(19) United States
(12) Patent Application Publication
(10) Pub. No.: US 2014/0288218 A1
(43) Pub. Date: Sep. 25, 2014

(54) SCRATCH SELF-RECOVERING PAINT COMPOSITION

(71) Applicants: KIA MOTORS CORPORATION, Seoul (KR); HYUNDAI MOTOR COMPANY, Seoul (KR)

(72) Inventors: Seon-Ho Jang, Hwasung (KR); Ho-Tak Jeon, Hwasung (KR); Kie-Youn Jeong, Hwasung (KR)

(21) Appl. No.: 13/934,578

(22) Filed: Jul. 3, 2013

(30) Foreign Application Priority Data
Mar. 22, 2013 (KR) 10-2013-0031017

(51) Int. Cl. C09D 167/03; C09D 133/00; C09D 7/06

(52) U.S. Cl. CPC C09D 167/03; C09D 7/06; C09D 133/00
USPC 524/102; 524/513

(57) ABSTRACT

A scratch self-recovering paint composition is provided that may maintain physical properties sufficient to be used for interior vehicle parts and may slowly recover from scratches generated on the surface of the paint composition. Specifically, the self-recovering paint composition includes a polyester polyol resin which is a soft resin, an acryl polyol resin which is a hard resin, a curing agent, a wetting dispersing agent, a leveling agent, a UV additive, and the like, and thus the use lifespan of the interior material is extended, and the high-gloss paint of the interior material is maintained without additional costs.

### CROSS-REFERENCE TO RELATED APPLICATIONS

This application claims priority under 35 U.S.C. §119 to Korean Patent Application No. 10-2013-0031017, filed on Mar. 22, 2013, in the Korean Intellectual Property Office, the disclosure of which is incorporated herein by reference in its entirety.

### BACKGROUND

1. Field of the Invention

The present invention relates to a scratch self-recovering paint composition, and more particularly, to a scratch self-recovering paint composition which may recover from scratches generated on the surface of the paint composition through elasticity by including a polyester polyol resin, an acryl polyol resin, a curing agent, a wetting dispersing agent, a leveling agent, a ultraviolet (UV) additive and the like to the paint composition.

2. Description of the Related Art

With the recent trend of consumers, a number of high gloss specifications have been applied to interior vehicle parts. Processing methods of implementing high gloss, which have been currently applied to interior vehicle parts, are classified into a raw material injection method, a painting method, a film method, and the like. The painting method may show improved appearance and is advantageous in cost competitiveness and thus is a common processing method for many types of vehicles.

When a black color, which is most commonly used in interior parts of a vehicle, is implemented by the painting method, it is difficult to visually observe scratches generated on the surface of the interior parts to which a low-gloss paint is applied, but on interior parts to which a high-gloss paint in which a transparent and smooth painted surface is added to a black color, is applied, scratches generated on the surface thereof are more visible to the naked eye than on interior parts to which a low-gloss paint is applied.

To implement the high-gloss black color by a paint method, painting is generally performed twice. When a black color is painted once on a plastic injected material, and then a colorless and transparent clear paint is applied afterwards, a colorless and transparent clear paint layer is produced on the black color, and thus a similar effect as the black color having high gloss results.

In the processing method, the scratch resistance performance depends on physical properties of the colorless and transparent clear paint layer which is the uppermost layer in the painting process. In the related art, the scratch resistance performance has been improved by a method of suppressing generation of scratches by increasing hardness of a film of paint using an acryl polyol resin. However, although the method in the related art has improved scratch resistance performance, the method is insufficient in terms of elasticity of the film of paint due to the increased hardness, and thus previously generated scratches may remain visible, and when interior vehicle parts are under a scratch-generation environment over a long period of time, the effect of scratch resistance performance is insignificant.

### SUMMARY

The present invention provides a scratch self-recovering paint composition which may recover from scratches generated on the surface of the paint composition through elasticity of a soft resin such as a polyester polyol resin by including a polyester polyol resin, an acryl polyol resin, a curing agent, a wetting dispersing agent, a leveling agent, a UV additive and the like, and may maintain physical properties at a level that may be applied to interior vehicle parts using a hard resin such as an acryl polyol resin.

An exemplary embodiment of the present invention provides a scratch self-recovering paint composition that may include: about 30 wt. % (% by weight) to 40 wt. % of a polyester polyol resin and about 30 wt. % to 40 wt. % of an acryl polyol resin, based on a total weight of the paint composition. Specifically, it may be preferred that the paint composition further includes from about 20 wt. % to 40 wt. % of a curing agent. Further, it is preferred that the paint composition further includes from about 0.1 wt. % to 1 wt. % of a wetting dispersing agent, from about 0.1 wt. % to 1 wt. % of a leveling agent, and from about 0.5 wt. % to 2 wt. % of a UV additive.

In addition, it is preferred that the paint composition includes about 35 wt. % of the polyester polyol resin, about 35 wt. % by weight of the acryl polyol resin, about 28 wt. % by weight of the curing agent, about 0.2 wt. % of the wetting dispersing agent, about 0.2 wt. % of the leveling agent, and about 1.6 wt. % of the UV additive. In particular, it is preferred that the curing agent is hexamethylene diisocyanate (HDI), methylene diphenyl diisocyanate (MDI), toluene diisocyanate (TDI), or isophorone diisocyanate (IPDI). It is also preferred that the wetting dispersing agent is BYK-306, BYK-307, BYK-333, BYK-341, or BYK-310, that the leveling agent is BYK-353, BYK-356, or BYK-361, and that the UV additive is TINUVIN 292.

According to the exemplary embodiments of the present invention, it may be possible to slowly recover from scratches generated on a surface of a paint composition at normal temperature, which ranges between approximately 15 Celsius and 25 Celsius, due to elasticity of a polyester polyol resin, by including the polyester polyol resin or the like which is a soft resin.

In addition, it may be possible to secure physical properties, which are sufficient enough to be used for interior vehicle parts, by including an acryl polyol resin or the like which is a hard resin.

Furthermore, it may be possible to extend a use lifespan of an interior material by the scratch self-recovering performance, and maintain the high-gloss paint of the interior material without additional costs.

### BRIEF DESCRIPTION OF DRAWINGS

FIG. 1 is an exemplary photograph illustrating scratches generated on a specimen of the present invention.

FIG. 2 is an exemplary photograph in which scratches generated on the specimen of the present invention have been removed after 24 hours.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Terms or words used in the present specification and claims should not be interpreted as being limited to typical or dictionary meanings, but should be interpreted as meanings and concepts which comply with the technical spirit of the present invention, based on the principle that an inventor can appropriately define a concept of a term to describe his/her own invention in the best manner.

Hereinafter, the present invention will be described in detail.

The present invention is a scratch self-recovering paint composition that may include a polyester polyol resin, an acryl polyol resin, a curing agent, a wetting dispersing agent, a leveling agent, a UV additive, and the like, and has a performance in which flaws, such as scratches generated on a film of paint may be self-recovered over a period of time.

More specifically, the present invention may include about 30 wt. % to 40 wt. % of a polyester polyol resin, about 30 wt. % to 40 wt. % of an acryl polyol resin, about 20 wt. % to 40 wt. % of a curing agent, about 0.1 wt. % to 1 wt. % of a wetting dispersing agent, about 0.1 wt. % to 1 wt. % of a leveling agent, about 0.5 wt. % to 2 wt. % of a UV additive and the like, based on the total weight of the paint composition.

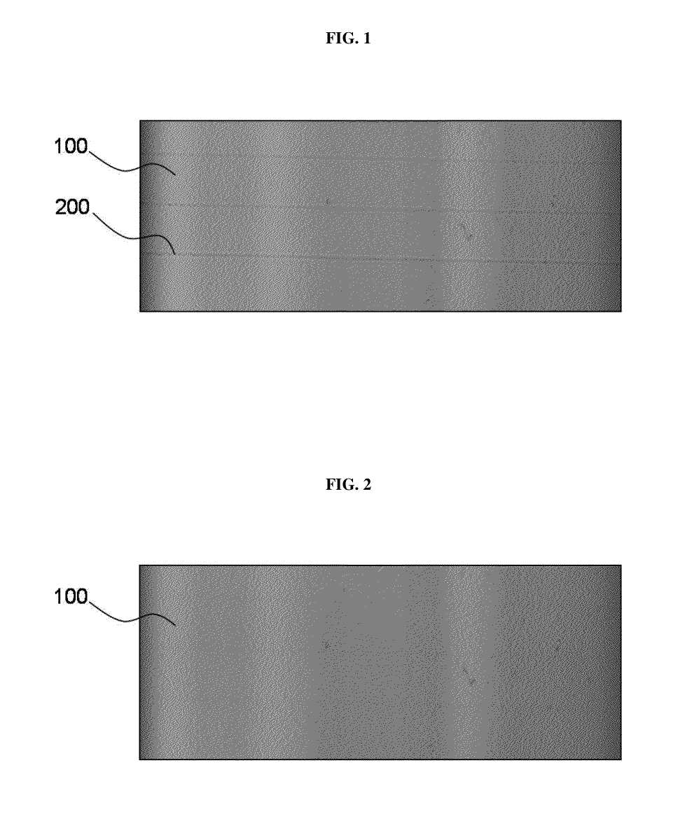

FIG. 1 is an exemplary photograph illustrating scratches generated on a specimen of the present invention, and FIG. 2 is an exemplary photograph in which scratches generated on the specimen of the present invention have been removed after 24 hours, and FIG. 2 shows that scratches 200 generated on a surface 100 of the paint composition of the present invention have been removed.

A paint and a varnish that includes paint, enamel and the like is a collective term for fluid materials which, when coated on a surface of a solid material, form a solid film, protect the surface of the solid, and enhance the appearance of the surface, and may be a mixture of a resin, a pigment, a curing agent, a dispersing agent, and the like.

A polyurethane paint is a collective term for paint and varnish having urethane bonds, and classified into alkid polyol, polyester polyol, polyester modified acryl polyol, acryl polyol and the like depending on the use purpose thereof. The polyurethane paint allows a hydroxy group (—OH) of the polyester polyol resin and the acryl polyol resin, which may be applied to the present invention, to react with an isocyanate group (—NCO) included in a curing agent to form a urethane bond (—NHCOO—) and improve physical properties of the film of paint.

The polyurethane paint may form a 3D-network structure (three-dimensional) by intermolecular chemical bonds after curing to increase the flexibility of the film of paint and thus may exhibit increased strength properties that the polyurethane paint recovers to an original state thereof even when strain due to scratches by external force and the like, increased durability to strain or heat compared to a thermoplastic elastomer, enhanced appearance of the film of paint, and increased paint workability.

Hereinafter, the constituent components and contents of the present invention will be described in detail.

### A. Constituent Component

### (1) Polyester Polyol Resin

The polyester polyol resin may be obtained by a condensation reaction of a polyfunctional acid and a polyhydric alcohol, and is a polymer that contains an ester bond (—COO—) and a hydroxy group (—OH) in a molecule thereof. Physical properties of the paint using a polyester polyol resin depend on the type of alcohol, the type of acid, a blending ratio, a molecular weight, a hydroxy group, an acid value and the like, and a flexible film of paint may be produced. Therefore, the polyester polyol resin may have flexible physical properties and thus an elasticity recovering effect when scratches are generated by external force and may be capable of removing the scratches generated over time.

Further, the polyester polyol resin may be present in an amount of preferably about 30 wt. % to 40 wt. % and more preferably about 35 wt. % based on the total weight of the paint composition, and the weight average molecular weight thereof is preferably about 4,000 to 7,000. When the content of the polyester polyol resin is less than 30 wt. %, physical properties of the paint composition may be expected improve, but it may be difficult to maintain the recovering performance against scratches due to reduction of the flexibility thereof. In contrast, when the content of the polyester polyol resin is greater than 40 wt. %, the recovering performance of the paint composition against scratches may be increased, but it may be difficult to maintain sufficient physical properties of the composition, and workability may be reduced due to generated stickiness of the film of paint.

In addition, when the polyester polyol resin has a weight average molecular weight less than 4,000, the molecular weight is may cause the reactivity of forming a film of paint to decrease, and thus it may be difficult to form a sufficient cross-linking bond, and the impact resistance thereof may decrease due to reduction in toughness of a film of paint itself. When the weight average molecular weight is greater than 7,000, the viscosity may increase, and thus the smoothness of the paint composition may be reduced.

### (2) Acryl Polyol Resin

The acryl polyol resin is a polymer that may be obtained by copolymerizing an acryl monomer having a hydroxy group (—OH), a styrene monomer, and the like. The acryl polyol resin may be generally prepared using a solution polymerization process of various polymerizable monomers and an acryl monomer that contains a hydroxy group in the presence of a radical polymerization initiator. Physical properties of the paint composition including the acryl polyol resin may be affected by the type of acryl monomer, a composition ratio, a molecular weight, a hydroxy group value, and the like, and quick-drying properties, weatherability, chemical resistance, mechanical properties, and the like may increase.

Moreover, the polyester polyol resin may be able to recover flaws such as scratches produced on the film of paint of the paint composition as a soft resin in the form of an original film of paint and remove the flaws, but may exhibit limited physical properties for use in interior vehicle parts and the like, and when an acryl polyol resin with increased physical properties is added thereto, physical properties of the paint composition may be improved, and thus the polyester polyol resin may contribute to maintaining reliability which may be applied to interior vehicle parts. Therefore, the acryl polyol resin in the present invention may compensate for insufficient physical properties of the polyester polyol resin, and it may be possible to secure physical properties which may be applied to interior vehicle parts by an appropriate mix of the components.

Furthermore, the acryl polyol resin may be present in an amount of preferably about 30 wt. % to 40 wt. % and more preferably about 35 wt. % based on the total weight of the paint composition, and the weight average molecular weight thereof is preferably from about 8,000 to 12,000. When the content of the acryl polyol resin is less than 30 wt. %, the scratch recovering performance may improve, but it may be difficult to maintain sufficient physical properties in the paint composition, and when the content thereof is greater than 40 wt. %, the appearance of the paint composition may deteriorate and the film of paint may break, and thus impact resistance thereof may be reduced.

Further, when the acryl polyol resin has a weight average molecular weight less than 4,000, the molecular weight may decrease causing difficulty in forming a sufficient crosslink and the reaction times may rapid increase and heat generation may rapidly occur, and thus the synthesis itself may be unstable. In addition, when the weight average molecular weight is greater than 7,000, the viscosity may increase, and thus a handling problem may occur. Therefore, the recovering performance and physical properties of the composition may be optimized by selecting an optimal blending ratio of the polyester polyol resin and the acryl polyol resin.

### (3) Curing Agent

The curing agent is an isocyanate prepolymer that may have a plurality of isocyanate groups (—NCO) at a terminal end of the molecule, and may be bonded to a polyester polyol, an alkyd polyol, an acryl polyol and the like to form a crosslinked film of paint that includes urethane bonds, thereby improving physical properties of the paint composition. More specifically, the curing agent may be supplied in a form where diisocyanate is included, and the type of diisocyanate included in the curing agent may be classified into aromatic and aliphatic diisocyanates. Examples of the aromatic diisocyanate include toluene diisocyanate (TDI), methylene diphenyl diisocyanate (MDI), xylene diisocyanate (XDI), naphthalene diisocyanate (NDI), and the like, in which an isocyanate group is directly bonded to a benzene ring, and examples of the aromatic diisocyanate include isophorone diisocyanate (IPD), hexamethylene diisocyanate (HDI) and the like.

It is preferred that the curing agent applied to the present invention may be one or more selected from a group consisting of toluene diisocyanate (TDI), methylene diphenyl diisocyanate (MDI), hexamethylene diisocyanate (HDI), isophorone diisocyanate (IPDI) and the like. More preferably, the curing agent is hexamethylene diisocyanate (HDI), methylene diphenyl diisocyanate (MDI), toluene diisocyanate (TDI), isophorone diisocyanate (IPDI) and the like.

In addition, the curing agent may be present in an amount preferably about 20 wt. % to 40 wt. % and more preferably 28 wt. % based on the total weight of the paint composition. When the content of the curing agent is less than 20 wt. %, the curing agent may not form a sufficient crosslinking bond with the polyester polyol resin and the acryl polyol resin and physical properties of the composition may deteriorate due to insufficient curing, and when the content thereof is greater than 40 wt. %, the paint may be rapidly cured causing a popping phenomenon to occur on the film of paint, or shrinkage of the film of paint to be generated during the paint coating, and thus physical properties of the composition may deteriorate.

### (4) Wetting Dispersing Agent

The wetting dispersing agent is a silicone additive that may improve the surface slipping property, and may reduce the surface tension of the paint composition to increase the spreadability of the composition and may increase the contact area to improve adhesion performance to the contact surface. The reduction in surface tension of the paint composition may prevent cratering which may occur when the film of paint dries, and the generation of scratches on the surface may be suppressed by improving slipping property on the surface of the paint composition. In addition, when the slipping property is improved, scratch resistance and contamination resistance of the composition may be improved, washing may be easily performed, and adhesion resistance may be improved.

The wetting dispersing agent may preferably be BYK-306, BYK-307, BYK-333, BYK-341, BYK-310 or the like as a silicone additive including polydimethylsiloxane as a main component, and more preferably may be BYK-307. Furthermore, the wetting dispersing agent may be present in an amount preferably about 0.1 wt. % to 1 wt. % and more preferably 0.2 wt. % based on the total weight of the paint composition. When the content of the wetting dispersing agent is less than 0.1 wt. %, the surface tension of the paint composition may be sufficiently reduced, and when the content thereof is greater than 1 wt. %, the number of silicone molecules of the wetting dispersing agent may be increased between a lower layer and a paint layer, and thus the surface adhesion property of the paint composition may deteriorate.

### (5) Leveling Agent

The leveling agent may also be referred to as a leveling agent for surface coating or a surface modifying agent, and is an additive which may improve the fluidity of the film of paint, may allow the paint composition to have a uniform surface, may inhibit the occurrence of defects generated on the surface of the film of paint, such as a writing brush trace, a roller trace, an orange peal phenomenon, cratering, a pin hole, and uneven coloring, and may improve the smoothness thereof.

Further, the leveling agent may preferably be BYK-353, BYK-356, BYK-361 or the like as an acrylate additive including polyacrylate as a main component, but more preferably may be BYK-359. Furthermore, the leveling agent may be present in an amount preferably about 0.1 wt. % to 1 wt. % and more preferably about 0.2 wt. % based on the total weight of the paint composition. When the content of the leveling agent is less than 0.1 wt. %, it may be difficult to provide a uniform surface of the composition, and when the content thereof is greater than 1 wt. %, the adhesion property may be reduced due to an excessive increase in fluidity of the composition.

### (6) UV Additive

The UV additive may improve resistance to photo-aging of the composition by UV rays. A paint composition may be exposed to visible rays and UV rays in the atmosphere for a long period of time, and UV rays have energy higher than visible rays and thus change color to cause yellowing, decoloration or discoloration, wherein the UV additive may suppress the phenomenon.

To implement high gloss of the surface of the paint composition, a UV additive with a substantially low gloss reduction was selected for the UV additive applied to the present invention, which may consist of a mixture of bis (1,2,2,6,6-pentamethyl-4-piperidinyl)-sebacate) and 1-(methyl)-8-(1,2,2,6,6-pentamethyl-4-piperidinyl)-sebacate, and may preferably be TINUVIN 292 with a specific weight of 0.99 as a pale yellow liquid.

Further, to prevent phenomena, such as cracking, reduction in gloss, peeling-off, and change in color of the paint composition, TINUVIN 1130, TINUVIN 384, TINUVIN 928, TINUVIN 328 or the like may be mixed with the TINUVIN 292, and the mixture may be used. In addition, the UV additive may be present in an amount preferably about 0.5 wt. % to 2% and more preferably about 1.6 wt. % based on the total weight of the paint composition. When the content of the UV additive is less than 0.5 wt. %, a sufficient light resistance effect may not be obtained, and when the content thereof is greater than 2 wt. %, the transparency of the film of paint may be reduced due to the pale yellow color of the UV additive itself.

### B. Use

The scratch self-recovering paint composition according to an exemplary embodiment of the present invention may be used as paint for interior vehicle parts, and the like.

### EXAMPLE

Hereinafter, the present invention will be described in more detail through the Examples. These Examples are only for illustrating the present invention, and it will be obvious to those skilled in the art that the scope of the present invention is not interpreted to be limited by these Examples.

Specimens of the scratch self-recovering paint composition in the Examples and the Comparative Examples according to the exemplary embodiment of the present invention were prepared with reference to the constituent components and contents of the following Table 1, and then physical properties thereof were compared and summarized in the following Table 2.

TABLE 1

| | | | Comparative | Comparative | Comparative | Comparative |
|---|---|---|---|---|---|---|
| Classification | Unit | Example 1 | Example 1 | Example 2 | Example 3 | Example 4 |
| Resin 1 | % by | 35 | 70 | 50 | 20 | 0 |
| (Polyester polyol) | weight | | | | | |
| Resin 2 | % by | 35 | 0 | 20 | 50 | 70 |
| (Acryl polyol) | weight | | | | | |
| Curing agent | % by | 28 | 28 | 28 | 28 | 28 |
| (Isocyanate) | weight | | | | | |
| Wetting dispersing | % by | 0.2 | 0.2 | 0.2 | 0.2 | 0.2 |
| agent | weight | | | | | |
| (BYK-307) | | | | | | |
| Leveling agent | % by | 0.2 | 0.2 | 0.2 | 0.2 | 0.2 |
| (BYK-359) | weight | | | | | |
| UV additive | % by | 1.6 | 1.6 | 1.6 | 1.6 | 1.6 |
| (TINUVIN 292) | weight | | | | | |

Table 1 shows the results of comparing the constituent components and contents in the Examples and the Comparative Examples according to an exemplary embodiment of the present invention, and the constituent components of the Examples and the Comparative Examples are the same as each other, but the contents of the polyester polyol resin and the acryl polyol resin thereof are different from each other.

More specifically, the polyester polyol resin and the acryl polyol resin were added at the same ratio in Example 1, and for Comparative Examples 1 to 4, the ratio of the polyester polyol resin was decreased from 70 wt. % to 0 wt. % from Comparative Example 1 to Comparative Example 4, the ratio of the acryl polyol resin was conversely increased from 0 wt. % to 70 wt. %, and the difference in physical properties is summarized in the following Table 2.

TABLE 2

| | | Compar- | Compar- | Compar- | Compar- |
|---|---|---|---|---|---|
| Classifi- | Example | ative | ative | ative | ative |
| cation | 1 | Example 1 | Example 2 | Example 3 | Example 4 |
| Scratch | ⊚ | ⊚ | ⊚ | Δ | X |
| resistance | | | | | |
| (After 24 | | | | | |
| hours) | | | | | |
| Initial | ⊚ | ◯ | ⊚ | ⊚ | ⊚ |
| adhesion | | | | | |
| property | | | | | |
| Sun cream | ◯ | X | Δ | ◯ | ◯ |
| resistance | | | | | |
| Wet | ◯ | X | Δ | ◯ | ◯ |
| resistance | | | | | |
| Abrasion | ◯ | Δ | Δ | ◯ | ◯ |
| resistance | | | | | |
| Light | ⊚ | ⊚ | ⊚ | ⊚ | ⊚ |
| resistance | | | | | |

⊚: Superior
◯: Excellent
Δ: Normal
X: Weak

Table 2 shows the results of summarizing the difference in physical properties of the specimens prepared according to the constituent components and the contents of Table 1. More specifically, Table 2 shows that in Example 1 in which the polyester polyol resin and the acryl polyol resin were added at the same ratio, all the physical properties are superior.

Furthermore, Table 2 shows that in the case of Comparative Examples 1 to 4, as the ratio of the polyester polyol resin was decreased from 70 wt. % to 0 wt. % from Comparative Example 1 to Comparative Example 4, scratch resistance that had increased gradually decreased, and as the ratio of the acryl polyol resin is increased from 0 wt. % to 70 wt. % from Comparative Example 1 to Comparative Example 4, sun scream resistance, wet resistance, and abrasion resistance, which had been decreased or stable, gradually increased. Therefore, the Examples and the Comparative Examples shows that it may be possible to obtain a composition with generally increased physical properties when the polyester polyol resin and the acryl polyol resin are added at a similar or the same ratio.

As described above, the present invention has been described in relation to exemplary embodiments of the present invention, but the embodiments are only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A scratch self-recovering paint composition comprising:
about 30% by weight to 40% by weight of a polyester polyol resin; and
about 30% by weight to 40% by weight of an acryl polyol resin, based on a total weight of the paint composition.

2. The paint composition of claim 1, further comprising:
about 20% by weight to 40% by weight of a curing agent.

3. The paint composition of claim 2, further comprising:
about 0.1% by weight to 1% by weight of a wetting dispersing agent;
about 0.1% by weight to 1% by weight of a leveling agent; and
about 0.5% by weight to 2% by weight of a UV additive.

4. The paint composition of claim 3, wherein the paint composition comprises: about 35% by weight of the polyester polyol resin, about 35% by weight of the acryl polyol resin, about 28% by weight of the curing agent, about 0.2% by weight of the wetting dispersing agent, about 0.2% by weight of the leveling agent, and about 1.6% by weight of the UV additive.

5. The paint composition of claim 2, wherein the curing agent is hexamethylene diisocyanate (HDI), methylene diphenyl diisocyanate (MDI), toluene diisocyanate (TDI), or isophorone diisocyanate (IPDI).

6. The paint composition of claim 3, wherein the wetting dispersing agent is BYK-306, BYK-307, BYK-333, BYK-341, or BYK-310.

7. The paint composition of claim 3, wherein the leveling agent is BYK-353, BYK-356, or BYK-361.

8. The paint composition of claim 3, wherein the UV additive is TINUVIN 292.
